(19) United States
(12) Patent Application Publication
(10) Pub. No.: US 2003/0147109 A1
(43) Pub. Date: Aug. 7, 2003

(54) Carriage structure for use with image scanner

(76) Inventor: Chuwn-Jen Chien, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/218,274

(22) Filed: Aug. 13, 2002

(30) Foreign Application Priority Data
Feb. 5, 2002 (TW) 091101958

(51) Int. Cl. H04N 1/04; H04N 1/46

(52) U.S. Cl. 358/505; 358/474

(57) ABSTRACT

A carriage structure for use with an image scanner is disclosed. The carriage structure includes a first reflective mirror set for reflecting light from a scanned object, a lens disposed downstream of the first reflective mirror set in an optical path direction for refracting the light reflected by the first reflective mirror set, a second reflective mirror set disposed downstream of the lens in the optical path direction for further reflecting the light refracted by the lens, and a photoelectric conversion device disposed downstream of the second reflective mirror set in the optical path direction for receiving and converting the light from the second reflective mirror set into electric level signals.

### FIELD OF THE INVENTION

The present invention relates to a carriage structure for use with an image pickup device, and more particularly to a carriage structure for use with an image scanner. BACKGROUND OF THE INVENTION

Please refer to FIG. 1 which is a schematic diagram illustrating an optical path for scanning a document 10. The image of the scanned document 10 is refracted to a charge-coupled device (CCD) 12 via a lens 11. The optical path length between the scanned document 10 and the lens 11 is defined as the objective length while the optical path length between the lens 11 and the CCD 12 is defined as the image length. In addition, the optical path length between the lens 11 and the CCD 12, i.e. the image length, determines a visual angle.

Please refer to FIG. 2 which is a cross-sectional side view illustrating a carriage structure of a conventional image scanner. As shown in FIG. 2, the objective length between the scanned document 10 and the lens 11 is folded via a series of reflective mirrors 13 for reducing the length of the carriage 20. It is also preferred that the image length be shortened to further reduce the length of the carriage 20. The reduction of the image length, however, is likely to make the document edges out of focus because the visual angle is determined by the image length in a manner that the visual angle increases with the decrease of the image length. Thus, for properly focusing the entire document, the image length should be kept above a certain level, so the length of the carriage cannot be efficiently reduced.

Please refer to FIG. 3 which is a schematic top view illustrating a typical image scanner. As shown in FIG. 3, a scanning platform 30 is used for placing the scanned document thereon, so the size of that the scanning platform 30 has to conform to that of the document. In other words, the size is fixed, and cannot be reduced. In addition, there must be a redundant region 31 used for receiving the carriage 20. It is apparent that one possible way to reduce the size of the image scanner is to reduce the size of the region 31. Unfortunately, it is impractical to reduce the size of the region 31 because the length of the carriage for the conventional image scanner cannot be efficiently reduced, as mentioned above.

Therefore, the purpose of the present invention is to develop a carriage structure for use with an image scanner to deal with the above situations encountered in the prior art.

### SUMMARY OF THE INVENTION

An object of the present invention is to provide a carriage structure for use with an image scanner for efficiently reducing the length of the carriage and further the size of the image scanner.

According to an aspect of the present invention, there is provided a carriage structure for use with an image scanner. The carriage structure includes a first reflective mirror set for reflecting light from a scanned object, a lens disposed downstream of the first reflective mirror set in an optical path direction for refracting the light reflected by the first reflective mirror set, a second reflective mirror set disposed downstream of the lens in the optical path direction for further reflecting the light refracted by the lens, and a photoelectric conversion device disposed downstream of the second reflective mirror set in the optical path direction for receiving and converting the light from the second reflective mirror set into electric level signals.

Preferably, the second reflective mirror set includes a first reflective mirror disposed downstream of the lens in the optical path direction for reflecting the light from the lens by substantially 90 degrees, and a second reflective mirror disposed downstream of the first reflective mirror in the optical path direction for reflecting the light from the first reflective mirror by substantially 90 degrees to the photoelectric conversion device.

Preferably, the second reflective mirror set includes a first reflective mirror disposed downstream of the lens in the optical path direction for reflecting the light from the lens by a first angle over 90 degrees, and a second reflective mirror disposed downstream of the first reflective mirror in the optical path direction for reflecting the light from the first reflective mirror by a second angle over 90 degrees to the photoelectric conversion device.

Preferably, the second reflective mirror set essentially comprises a reflective mirror disposed downstream of the lens in the optical path direction for reflecting the light from the lens to the photoelectric conversion device.

For example, the photoelectric conversion device can be a charge-coupled device (CCD).

According to another aspect of the present invention, there is provided a carriage structure for use with an image pickup. The carriage includes a first light-guiding device for changing at least once the direction of light from a scanned object, a focusing device disposed downstream of the first light-guiding device in an optical path direction for focusing the light outputted from the first light-guiding device, a second light-guiding device disposed downstream of the focusing device in the optical path direction for changing at least once the direction of the light from the focusing device, and a photoelectric conversion device disposed downstream of the second light-guiding device in the optical path direction for receiving and converting the light from the second light-guiding device into electric level signals.

Preferably, the second light-guiding device includes a first reflective mirror disposed downstream of the focusing device in the optical path direction for reflecting the light from the focusing device, and a second reflective mirror disposed downstream of the first reflective mirror in the optical path direction for reflecting the light from the first reflective mirror.

Preferably, the second light-guiding device essentially includes a first reflective mirror disposed downstream of the focusing device in the optical path direction for reflecting the light from the focusing device, and a second reflective mirror disposed downstream of the first reflective mirror in the optical path direction for reflecting the light from the first reflective mirror to the photoelectric conversion device.

Preferably, the second light-guiding device essentially comprises a reflective mirror disposed downstream of the focusing device in the optical path direction for reflecting the light from the focusing device to the photoelectric conversion device.

For example, the photoelectric conversion device can be a charge-coupled device (CCD).

For example, the image pickup device can be an image scanner.

According to a further aspect of the present invention, a carriage structure for use with an image pickup device includes a focusing device for focusing light from a scanned object, a light-guiding device disposed downstream of the focusing device in an optical path direction for changing at least once the direction of the focused light from the focusing device, and a photoelectric conversion device disposed downstream of the light-guiding device in the optical path direction for receiving and converting the light from the light-guiding device into electric level signals.

### BRIEF DESCRIPTION OF THE DRAWINGS

The present invention may best be understood through the following description with reference to the accompanying drawings, in which:

FIG. 1 is a schematic diagram illustrating an optical path for scanning a document;

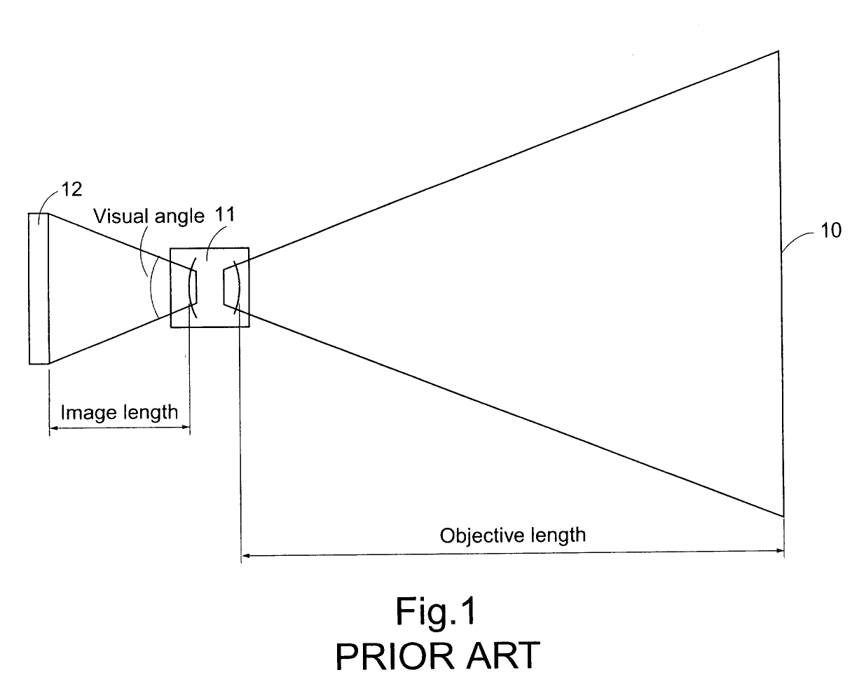

FIG. 2 is a cross-sectional side view illustrating a carriage structure of a conventional image scanner.;

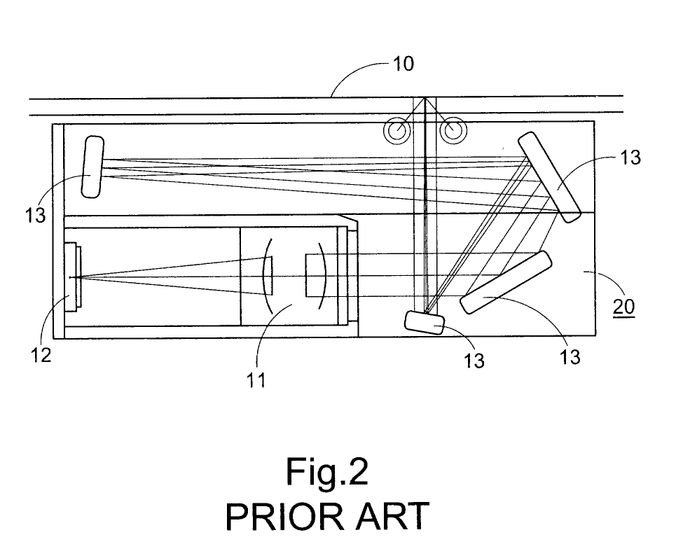

FIG. 3 is a schematic top view illustrating a typical image scanner;

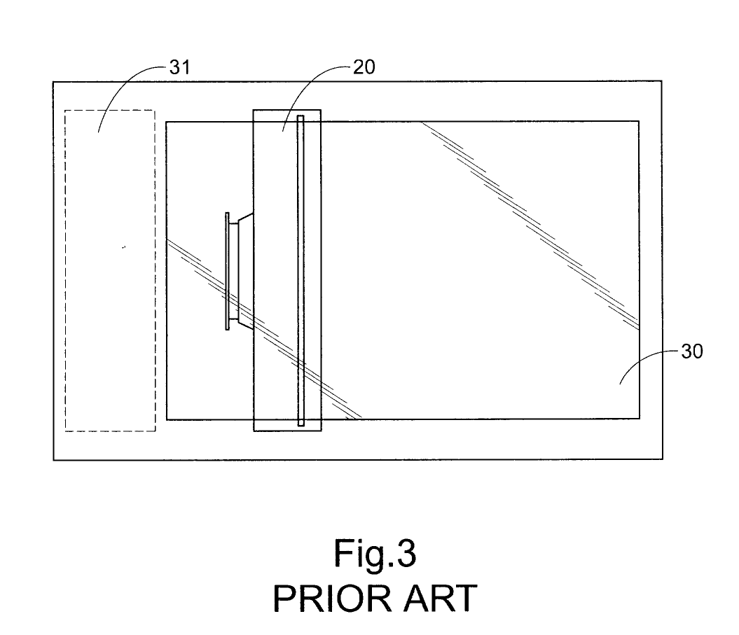

FIG. 4 is a cross-sectional side view illustrating a preferred embodiment of a carriage structure of an image scanner according to the present invention;

FIG. 5 is a cross-sectional side view illustrating another preferred embodiment of a carriage structure of an image scanner according to the present invention; and

FIG. 6 is a cross-sectional side view illustrating a further preferred embodiment of a carriage structure of an image scanner according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

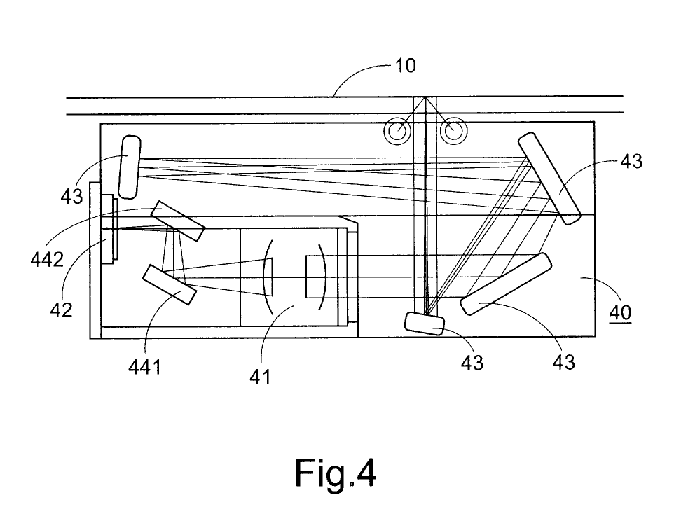

Please refer to FIG. 4 which is a cross-sectional side view illustrating a preferred embodiment of a carriage structure of an image scanner according to the present invention. The carriage 40 includes a lens 41, a photoelectrical conversion device 42, a first reflective mirror set 43, and a second reflective mirror set including a first reflective mirror 441 and a second reflective mirror 442. As shown in FIG. 4, the first reflective mirror set 43 consists of a series of reflective mirrors for sequentially reflecting the light from a scanned object 10. Subsequently, the light is refracted by the lens 41, which is disposed downstream of the first reflective mirror set 43 in an optical path direction, to the first and second reflective mirrors 441 and 442. The first and second reflective mirrors 441 and 442 are disposed downstream of the lens 41 in the optical path direction for reflecting the light from the lens by substantially 90 degrees, respectively, to the photoelectrical conversion device 42, e.g. a charge-coupling device (CCD). Then, the reflected light is converted into electric level signals by the CCD. By additionally providing the two reflective mirrors 441 and 442, the downstream light path is further folded, compared to the prior art. In other words, the distance between the lens 41 and the CCD 42 is shortened under the same required light-path length, and the section of the light path between the two mirrors 441 and 442 does not contribute to the length of the carriage 40. Thus, the length of the carriage 40 can be efficiently reduced.

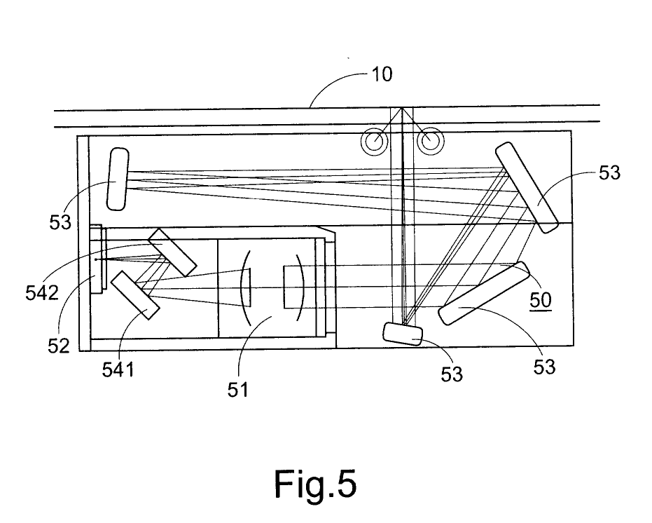

Please refer to FIG. 5 which is a cross-sectional side view illustrating another preferred embodiment of a carriage structure of an image scanner according to the present invention. The carriage 50 includes a lens 51, a photoelectrical conversion device 52, a first reflective mirror set 53, and a second reflective mirror set including a first reflective mirror 541 and a second reflective mirror 542. The structures and functions of those elements in the carriage 50 are similar to those in the carriage 40 of FIG. 4 except that the first and second reflective mirrors 541 and 542 reflect the light from the lens 51 by a first and a second angles over 90 degrees, respectively. In this embodiment, the distance between the two mirrors 541 and 542 and thus the length of the carriage 50 can be further reduced because the section of the optical path between the first and second reflective mirrors 541 and 542 overlaps with that between the lens 51 and the mirror 541 and that between the mirror 542 and the CCD 52.

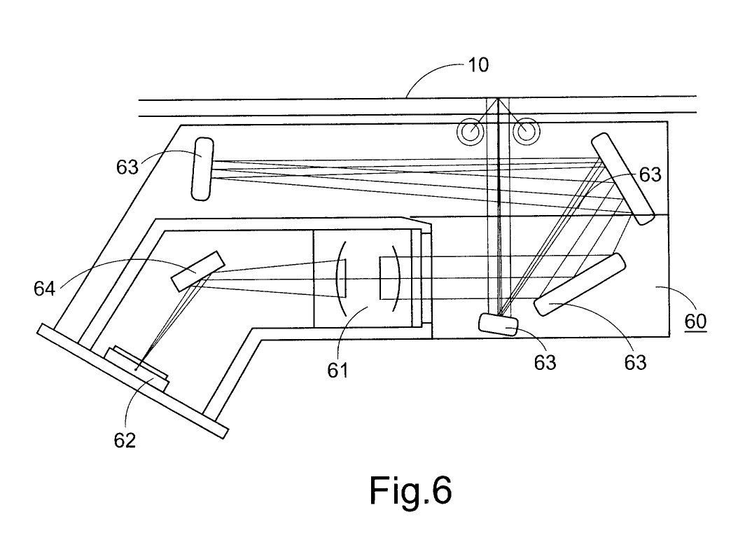

Please refer to FIG. 6 which is a cross-sectional side view illustrating a further preferred embodiment of a carriage structure of an image scanner according to the present invention. The carriage 60 includes a lens 61, a photoelectrical conversion device 62, a first reflective mirror set 63, and a reflective mirror 64. The structures and functions of those elements in the carriage 60 are similar to those in the carriage 40 of FIG. 4 except that only one reflective mirrors 64 is provided downstream of the lens 61 in the optical path direction. In other words, in this embodiment, after being refracted by the lens 61, the light is reflected by the reflective mirror 64 instead of two reflective mirrors in FIGS. 4 and 5. While the reduction of the length of the carriage 60 may achieved to an extent with less cost.

To sum up, the carriage structure according to the present invention has reduced length by using at least one reflective mirror downstream of the lens for folding the optical path under the requirement of a certain image length. Therefore, the size of the entire image scanner can also be efficiently reduced.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A carriage structure for use with an image scanner, comprising:
a first reflective mirror set for reflecting light from a scanned object;
a lens disposed downstream of said first reflective mirror set in an optical path direction for refracting said light reflected by said first reflective mirror set;
a second reflective mirror set disposed downstream of said lens in said optical path direction for further reflecting said light refracted by said lens; and
a photoelectric conversion device disposed downstream of said second reflective mirror set in said optical path direction for receiving and converting said light from said second reflective mirror set into electric level signals.

2. The carriage structure according to claim 1 wherein said second reflective mirror set comprises:
a first reflective mirror disposed downstream of said lens in said optical path direction for reflecting said light from said lens by substantially 90 degrees; and
a second reflective mirror disposed downstream of said first reflective mirror in said optical path direction for reflecting said light from said first reflective mirror by substantially 90 degrees to said photoelectric conversion device.

3. The carriage structure according to claim 1 wherein said second reflective mirror set comprises:
a first reflective mirror disposed downstream of said lens in said optical path direction for reflecting said light from said lens by a first angle over 90 degrees; and
a second reflective mirror disposed downstream of said first reflective mirror in said optical path direction for reflecting said light from said first reflective mirror by a second angle over 90 degrees to said photoelectric conversion device.

4. The carriage structure according to claim 1 wherein said second reflective mirror set essentially comprises a reflective mirror disposed downstream of said lens in said optical path direction for reflecting said light from said lens to said photoelectric conversion device.

5. The carriage structure according to claim 1 wherein said photoelectric conversion device is a charge-coupled device (CCD).

6. A carriage structure for use with an image pickup device, comprising:
a first light-guiding device for changing at least once the direction of light from a scanned object;
a focusing device disposed downstream of said first light-guiding device in an optical path direction for focusing said light outputted from said first light-guiding device;
a second light-guiding device disposed downstream of said focusing device in said optical path direction for changing at least once the direction of said light from said focusing device; and
a photoelectric conversion device disposed downstream of said second light-guiding device in said optical path direction for receiving and converting said light from said second light-guiding device into electric level signals.

7. The carriage structure according to claim 6 wherein said second light-guiding device comprises:
a first reflective mirror disposed downstream of said focusing device in said optical path direction for reflecting said light from said focusing device; and
a second reflective mirror disposed downstream of said first reflective mirror in said optical path direction for reflecting said light from said first reflective mirror.

8. The carriage structure according to claim 6 wherein said second light-guiding device essentially comprises:
a first reflective mirror disposed downstream of said focusing device in said optical path direction for reflecting said light from said focusing device; and
a second reflective mirror disposed downstream of said first reflective mirror in said optical path direction for reflecting said light from said first reflective mirror to said photoelectric conversion device.

9. The carriage structure according to claim 6 wherein said second light-guiding device essentially comprises a reflective mirror disposed downstream of said focusing device in said optical path direction for reflecting said light from said focusing device to said photoelectric conversion device.

10. The carriage structure according to claim 6 wherein said photoelectric conversion device is a charge-coupled device (CCD).

11. The carriage structure according to claim 6 wherein said image pickup device is an image scanner.

12. A carriage structure for use with an image pickup device, comprising:
a focusing device for focusing light from a scanned object;
a light-guiding device disposed downstream of said focusing device in an optical path direction for changing at least once the direction of said focused light from said focusing device; and
a photoelectric conversion device disposed downstream of said light-guiding device in said optical path direction for receiving and converting said light from said light-guiding device into electric level signals.

13. The carriage structure according to claim 12 wherein said light-guiding device comprises:
a first reflective mirror disposed downstream of said focusing device in said optical path direction for reflecting said light from said focusing device; and
a second reflective mirror disposed downstream of said first reflective mirror in said optical path direction for reflecting said light from said first reflective mirror.

14. The carriage structure according to claim 12 wherein said light-guiding device essentially comprises a reflective mirror disposed downstream of said focusing device in said optical path direction for reflecting said light from said focusing device to said photoelectric conversion device.

15. The carriage structure according to claim 12 wherein said photoelectric conversion device is a charge-coupled device (CCD).

16. The carriage structure according to claim 12 wherein said image pickup device is an image scanner.
